(19) United States
(12) Patent Application Publication
(10) Pub. No.: US 2017/0249126 A1
(43) Pub. Date: Aug. 31, 2017

(54) EASY STORM TOPOLOGY DESIGN AND EXECUTION

(71) Applicant: International Business Machines Corporation, Armonk, NY (US)

(72) Inventor: Yacov Manevich, Beer Sheva (IL)

(21) Appl. No.: 15/054,272

(22) Filed: Feb. 26, 2016

(51) Int. Cl. G06F 9/44; G06F 11/36

(52) U.S. Cl. CPC G06F 8/20; G06F 11/3664

(57) ABSTRACT

An approach to generating a computational topology for a computational platform. The approach uses a development platform generates nodes of a topology and logic for the nodes to accomplish the desired computation. The approach then connects the nodes based on the desired data flow path. The approach then converts the nodes, logic and connections to a computational topology in a format compatible with the computational platform. The approach deploys the computation topology to the associated nodes of the computational platform. Output and error streams are connected from the nodes of the computational platform to the associated nodes of the development platform to provide feedback.

### BACKGROUND OF THE INVENTION

The present invention relates generally to the generation and testing of computational topologies and more specifically, to the generation and testing of computational topologies for Apache Storm by Apache Software Foundation.

Apache Storm, hereinafter Storm, is a distributed real-time computational system. Storm runs jobs called “topologies” which are flows of computing tasks represented as directed acyclic graphs, i.e., topology graphs, comprised of “Spouts” and “Bolts.” It should be noted that Spouts and Bolts are tasks used for data processing and are the primitives Storm provides for “Stream” transformations, wherein a Stream is an unbounded sequence of tuples. Further, it should be noted that a Spout can only output data to a Bolt while a Bolt can receive data from a Spout and/or a Bolt and output its data, i.e., processed result, to another Bolt. The vertices of a topology graph are Spouts and Bolts and the ordered sequences of spouts and bolts are the Streams, directing data from one vertex (Spout or Bolt) to another vertex (Bolt).

Implementing a topology on Storm comprises implementing Spouts and Bolts based on subclassing one or more base classes associated with the Spouts and Bolts, defining a topology graph, i.e., connecting the Spouts and Bolts with Streams, packaging the implementation, along with any required dependencies into a “Jar” file and uploading the Jar file to Storm for execution.

The difficulty of a storm implementation arises from a necessity of proficiency in both the Java programming language, an understanding of how to implement the various subclasses of Storm Bolts/Spouts and an understanding of the lifetime of a Storm topology. Further, Storm does not provide a debugging platform without deploying the topology to the production environment and any debugging information related to operational failures the developer must have access to the Storm logs located on the Storm execution nodes associated with the running topology.

### SUMMARY

According to an embodiment of the present invention, a method for generating a computational topology for a computational platform, the method comprising: generating, by a topology design component, one or more nodes associated with a topology in a format associated with the topology design component; generating, by the topology design component, logic associated with the one or more nodes, respectively; communicatively connecting, by the topology design component, the one or more nodes based on a desired data flow path; transforming, by the topology design component, the one or more nodes, the logic and the desired data flow path to a computational topology in a format associated with a computational platform; and deploying, by the topology design component, the computational topology to the computational platform for execution.

According to another embodiment of the present invention, a computer program product for generating a computational topology for a computational platform, the computer program product comprising: one or more computer readable storage media and program instructions stored on the one or more computer readable storage media, the program instructions comprising: program instructions to, generate, by a topology design component, one or more nodes associated with a topology in a format associated with the topology design component; program instructions to, generate, by the topology design component, logic associated with the one or more nodes, respectively; program instructions to, communicatively connect, by the topology design component, the one or more nodes based on a desired data flow path; program instructions to, transform, by the topology design component, the one or more nodes, the logic and the desired data flow path to a computational topology in a format associated with a computational platform; and program instructions to, deploy, by the topology design component, the computational topology to the computational platform for execution.

According to another embodiment of the present invention, a computer system for generating a computational topology for a computational platform, the computer system comprising: one or more computer processors; one or more computer readable storage media; program instructions stored on the one or more computer readable storage media for execution by at least one of the one or more computer processors, the program instructions comprising: program instructions to, generate, by a topology design component, one or more nodes associated with a topology in a format associated with the topology design component; program instructions to, generate, by the topology design component, logic associated with the one or more nodes, respectively; program instructions to, communicatively connect, by the topology design component, the one or more nodes based on a desired data flow path; program instructions to, transform, by the topology design component, the one or more nodes, the logic and the desired data flow path to a computational topology in a format associated with a computational platform; and program instructions to, deploy, by the topology design component, the computational topology to the computational platform for execution.

### BRIEF DESCRIPTION OF THE DRAWINGS

FIG. 1 is a functional block diagram generally depicting a topology computation generation environment, in accordance with an embodiment of the present invention;

FIG. 2 is a functional block diagram depicting a topology design component, in accordance with an embodiment of the present invention;

FIG. 3 is a flowchart depicting operational steps of a method for the generation of a computational topology, within a topology computation generation environment, in accordance with an embodiment of the present invention; and

FIG. 4 is a block diagram of components of a survey design computer and a user survey computer of a survey generation computing environment, in accordance with an embodiment of the present invention.

### DETAILED DESCRIPTION

The embodiments depicted and described herein recognize the benefits of providing a user, i.e., a topology developer, with a user interface (UI) for easily defining a topology, e.g., a Storm (by Apache Software Foundation) topology, and the logic associated with each component, e.g., spouts and bolts, of the Storm topology. Further, the user can test and debug the developed logic and the flow of the topology before deploying the topology to the Storm cluster for execution. These embodiments provide for deploying the generated and debugged topology to a computational platform and receiving output and error information from the computational platform for topology analysis.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

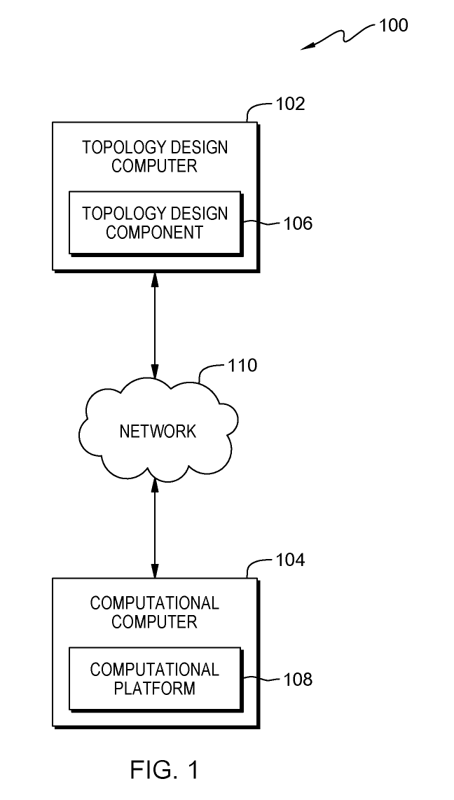

FIG. 1 is a functional block diagram illustrating, generally, an embodiment of a topology computation generation environment 100. The topology computation generation environment 100 comprises a topology design component 106 operating on a topology design computer 102, one or more computation platforms 108, e.g., Storm, operating on one or more computational computers 104 and a network 110 supporting communications between the topology design computer 102 and the one or more computational computers 104.

Topology design computer 102 can be a standalone computing device, management server, a web server, a mobile computing device, or any other electronic device or computing system capable of receiving, sending, and processing data. In other embodiments, Topology design computer 102 can represent a server computing system utilizing multiple computers as a server system. In another embodiment, Topology design computer can be a laptop computer, a tablet computer, a netbook computer, a personal computer, a desktop computer or any programmable electronic device capable of communicating with other computing devices (not shown) within survey design environment 100 via network 110.

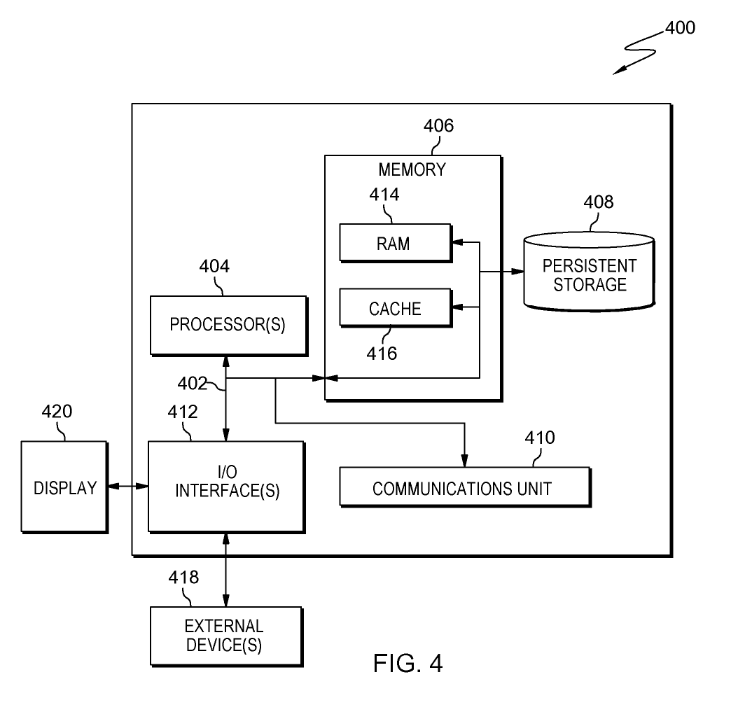

In another embodiment, survey design computer 102 represents a computing system utilizing clustered computers and components (e.g., database server computers, application server computers, etc.) that act as a single pool of seamless resources when accessed within topology computation design environment 100. Topology design computer 102 can include internal and external hardware components, as depicted and described in further detail with respect to FIG. 4. Topology design component 106 can be a framework for defining a logical flow of data from the input to the output of the topology, logic for the computational processing of the data at the different nodes of the topology, debugging of the logical flow and computational processing and receiving output and error messages associated with the topology.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between survey design computer 102 and user survey computer 104.

Computational computer 104 can be a standalone computing device, management server, a web server, a mobile computing device, or any other electronic device or computing system capable of receiving, sending, and processing data. In other embodiments, computational computer 104 can represent a server computing system utilizing multiple computers as a server system. In another embodiment, computational computer 104 can be a laptop computer, a tablet computer, a netbook computer, a personal computer, a desktop computer, or any programmable electronic device capable of communicating with other computing devices (not shown) within topology computation design environment 100 via network 110.

In another embodiment, computational computer 104 represents a computing system utilizing clustered computers and components (e.g., database server computers, application server computers, etc.) that act as a single pool of seamless resources when accessed within survey design environment 100. User computational computer 104 can include internal and external hardware components, as depicted and described in further detail with respect to FIG. 4. It should be noted that computational computer 104 can be a plurality of computational computers based on the size and distribution requirements of the created topology. Computational platform 108 can be, but without limitation, a real time computational system such as, but not limited to, Apache Storm.

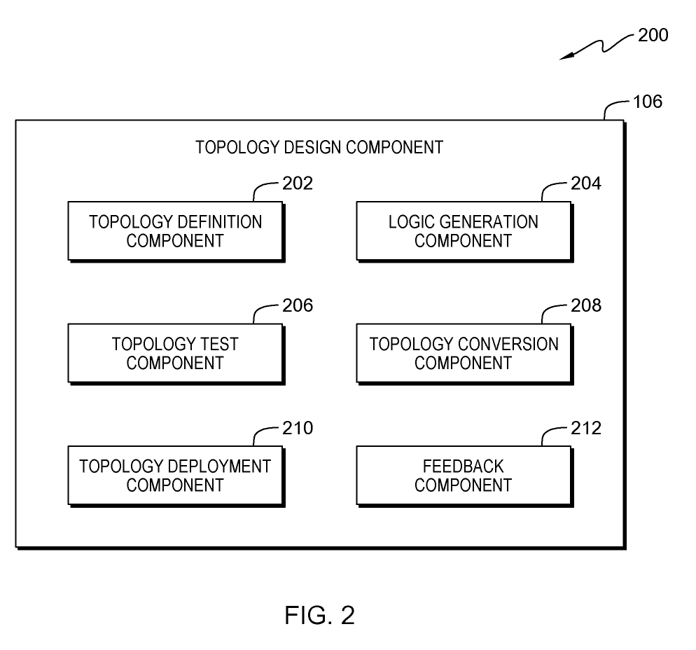

FIG. 2 is a functional block diagram 200 depicting topology design component 106 comprising topology definition component 202, logic generation component 204, topology test component 206, topology conversion component 208, topology deployment component 210 and feedback component 212.

Topology definition component 202 of an embodiment of the present invention provides the capability to create a topology comprised of nodes with inputs and/or outputs and data paths connecting the nodes and allowing for data flow between the nodes in the defined direction. A topology developer can select and/or generate the nodes and connect the nodes together based on the desired data flow and the computations associated with the nodes. It should be noted in the embodiments that nodes can comprise only inputs, both inputs and outputs and only outputs.

For example, a topology developer can select/create a node that can provide data from an online source, e.g., a Twitter feed, a news source, etc., and/or from input sensors such as, but not limited to, temperatures, counters, pressures, etc. The topology developer can output this data to one or more other nodes for further processing and repeating the process until the data has been manipulated to the extent desired by the topology developer. It should be noted in the embodiments that other sources can be employed to provide data to the topology.

Logic generation component 204 provides the capability to create logic for processing the data at one or more nodes of the created topology. The topology developer can decide what processing to do at each node and distribute the overall topology processing requirements around the different nodes of the topology. The topology developer can create the logic in any language desired and convert the language, with topology conversion component 208, to a form compatible with computational platform 108. For example, the topology developer can create the logic using the JavaScript language

Topology test component 206 provides the capability to test both the logic distributed to the nodes of the topology and the flow of the data between the nodes of the topology in a local environment. Accordingly, the topology can be tested and debugged before deployment to computational platform 108. The topology test component performs tests, for example, by executing the created logic in a single-stepping debug environment. In another testing example, the error and/or output streams from the executing logic can be displayed during the single-step debugging process.

Topology conversion component 208 provides the capability to convert the flow connections and the generated logic associated with the nodes from the implementation language to the language required by computational platform 108, i.e., the locally generated and debugged topology is input to topology conversion component 208 and topology conversion component 208 outputs a topology in a format compatible with computational platform 108.

Topology deployment component 210 provides the capability to deliver the components converted by topology conversion component 208 to the desired locations of the computational platform 108. The components can be delivered, for example, by calling functions associated with the computational platform 108 for integrating the components into computational platform 108.

Feedback component 212 provides the capability to receive data, e.g., output, error, etc. streams, from computational platform 108 associated with the operation of the topology. The received data streams can be consumed to detect errors in the generated logic and to monitor the status of the computations for tuning the generated logic.

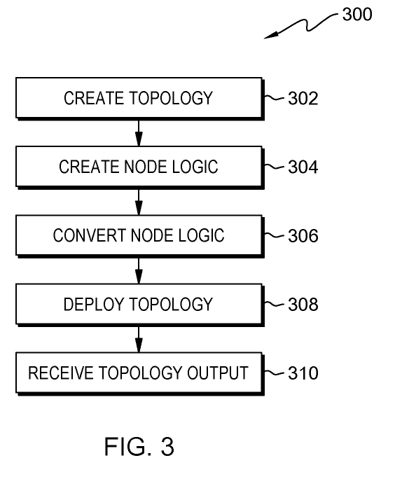

FIG. 3 is a flowchart of a method 300 depicting operational steps to create a topology and its associated logic, transform the topology to the desired computational platform, deploy the topology to the desired computational platform and receive feedback from the computational platform for error correction and logic tuning. Looking to step 302, a topology is created with the use of topology definition component 202 based on generating a logical flow of the desired data from one or more inputs toward one or more outputs. Next, at step 304, the method uses logic generation component 204 to create logic for operation on the data at any node defined in the topology where the topology designer desires processing of data. Next at step 306, the topology conversion component 208 converts the generated logic from the format selected for generation to the format required by the selected computational platform 108. It should be noted that the topology conversion component 208 can convert, for example, a node that represents an HTTP request to code in the Java language that performs the HTTP request.

Next, at step 308, the topology deployment component 210 distributes the converted logic to the associated nodes of the topology based on the computational platform 108. Next, at step 310, the feedback component 212 can receive feedback from the nodes of the topology. The feedback can be, but is not limited to, output and error information associated with the operation of the logic on the data provided to the node by data sources or by other nodes. It should be noted that data sources, as previously described, can include, but are not limited to, sensors, social media, databases, etc.

Optionally, technology test component 206 can be used to test the created logic before deployment to the individual nodes of the topology. Further, the technology test component 206 can be used to analyze feedback from feedback component 212 to diagnose problems detected in the feedback.

Considering an example implementation, a computational platform 108 can be Storm by the Apache Software Foundation and topology design component 106 can be implemented in Node-RED by International Business Machines Corporation. Node-RED is a tool for creating applications comprised of hardware devices, application programming interfaces (APIs) and online services communicatively connected together. An application created in Node-RED is depicted by a directed graph wherein the vertices are the components, e.g., input sensors, JavaScript functions, Hypertext Transfer Protocol (HTTP) input/output (I/O) components, etc., and the edges define the I/O redirection of the components. It should be noted that Node-RED provides a browser based flow editor for wiring components together based on selecting components from a palette and connecting the components to one another to create the edges.

Continuing with the example, the Node-RED flow topology can be converted to a Storm topology wherein each node, i.e., vertex, of the Node-RED topology is converted to a Storm Bolt/Spout and configured in the Storm run-time based on the configuration of the Node-RED node selected by the topology developer. It should be noted that any JavaScript code associated with a Node-RED node can be executed by a JavaScript engine such as, but not limited to, Rhino by the Mozilla Foundation. Other Node-RED node types can be converted to predefined classes that implement the functionality of the Node-RED nodes, respectively. It should further be noted that logs, errors and exceptions associated with each component in the topology can be sent toward the Node-RED HTTP endpoint for incorporation into the debug functionality of each Node-RED node, respectively.

A configuration associated with the example comprises a Node-RED server instance, a mediator and a Storm cluster. The Node-RED application runs on a known host and listens on a known port, the mediator (e.g., a server application) facilitates communications between the Node-RED instance and the Storm cluster. It should be noted that the known host and known port are known to the Storm topology, providing the capability for the Storm topology to connect to the Node-RED server and stream output and exceptions from the running topology for debugging and node logic optimization.

Functionally, the mediator will accept HTTP requests from Node-RED that contain the Node-RED flows, represented within Node-RED as JavaScript Object Notation (JSON) graphs, i.e., a set of vertices and a set of edges/wires. It should be noted that defined endpoints and user interface (UI) operations can be added via the JavaScript “server.js” and “main.js” source files in the Node-RED project. The mediator converts the flow to a Storm compatible topology and submits the topology to the Storm cluster.

Each Node-RED node type will have an associated Java class which can be configured prior to the execution. The bolts and spouts can be configured to output their logs and exceptions to the predefined endpoint of the Node-RED instance via HTTP.

Operationally, the example launches the Node-RED instance, the mediator and the Storm cluster. Next, the mediator connects to the Storm cluster with a Storm Nimbus Client class. Continuing, the Node-RED instance sends the mediator its host name and listening port. Next, the developer designs a topology and invokes a Node-RED function to send an HTTP request to the mediator through a redirection. It should be noted that the redirection is necessary based on the same-origin policy that browsers enforce upon applications, and the fact that the user interface is a browser application. Continuing, the mediator parses the JSON flow received from Node-RED, validates the JSON flow and creates a configuration object. It should be noted that validation comprises checking for node definitions, checking the graph is acyclic, etc. It should be further noted that the host name and port associated with the Node-RED application is incorporated into the configuration object, e.g., a “backtype.storm.Config” class.

Next, the mediator creates a Storm topology based on the Node-RED topology using the “TopologyBuilder” functionality of Storm, e.g., calls methods such as, but not limited to, “SetSpout” and “SetBolt” based on the topology requirements. A Node-RED vertex's “node_id” is passed to the constructor of the Spout or Bolt such that the configuration object has the key of “<node_id>.<attribute>=<value>.” It should be noted that providing the “node_id” ensures the uniqueness of each instance of the created Spout or Bolt class. It should further be noted that when each Storm Bolt/Spout is created, the configuration object is used for self-configuration such that when events such as, but not limited to, an exception is thrown in the “execute”/“nextTuple” methods or a log entry is written, the event can be sent to the Node-RED HTTP endpoint where the event can be viewed in the Node-RED editor user interface (UI).

Continuing, the mediator submits a predefined “jar” (Java archive file) with all the dependencies via the Storm method “StormSubmitter.submitJar” and then submits the configured topology which executes the topology. It should be noted in the embodiment that a Storm “jar” contains the collection of the components associated with the topology. Further, the JavaScript code is not compiled inside the “jar” but is passed via the configuration object, ensuring the dependencies submitted to Storm do not change between deployments and providing for reuse of dependencies and shortening of the time for topology deployment on Storm. As previously described, each Node-RED node, i.e., vertex, can be represented by its associated Java class and the function node's JavaScript code can be run inside a Storm Bolt/Spout with the assistance of “Rhino.” However, environmental objects that exist in the function node but do not exist in JavaScript can be implemented in Java and added to the execution context. For example, adding a console object can be easily implemented with:

```
public static class Console {
  public void log (String msg) {
    System.out.println (″console: ″ + msg)
  }
}
```

and added to the context execution with: ScriptableObject.defineProperty(global, “console”, new Console( ), ScriptableObject.READONLY; This method of extending the execution environment of the JavaScript code running in “Rhino” can be exploited to implement any existing Node-RED node functionality in Java. Accordingly, anything written in the JavaScript function node of Node-RED can be incorporated to run inside “Rhino,” making the implementation transparent for the topology designer using the Node-RED UI.

Considering debugging, the Node-RED debug node implementation can be modified to filter all but the exception and/or log entries relevant to the node(s) that is (are) connected to the Node-RED debug node(s) and to print the messages sent from the Storm topology in real-time. Accordingly, the topology developer can see the exceptions and/or log messages from the topology of interest on the Node-RED debug tab. Further, wherein the Storm Bolts and Spouts have knowledge of their identity in the corresponding Node-RED flow, they can send their identity along with the exceptions and/or logs allowing the Node-RED UI to associate the stream of exception/log entries to the appropriate Node-RED debug node. Further, an application programming interface (API) call tracking the topology state can be implemented in the mediator and the Node-RED UI can change to reflect the state of the topology, e.g., running, killed, etc., and buttons can be added for extended functionality, e.g., for terminating the running topology.

FIG. 4 depicts computer system 400, an example computer system representative of topology design computer 102 and computational computer 104. Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for generating a computational topology for a computational platform, the method comprising:
generating, by a topology design component, one or more nodes associated with a topology in a format associated with the topology design component;
generating, by the topology design component, logic associated with the one or more nodes, respectively;
communicatively connecting, by the topology design component, the one or more nodes based on a desired data flow path;
transforming, by the topology design component, the one or more nodes, the logic and the desired data flow path to a computational topology in a format associated with a computational platform; and
deploying, by the topology design component, the computational topology to the computational platform for execution.

2. The method of claim 1, further comprising:
receiving, by the topology design component, data streams associated with an operational status of the computational topology executing on the computational platform; and
debugging, by the topology design component, the computational topology based on information associated with the data streams.

3. The method of claim 2, wherein the topology design component is Node-RED by International Business Machines Corporation and the computational platform is Storm by Apache Software Foundation.

4. The method of claim 1, wherein the logic is developed in JavaScript and executed by a JavaScript engine associated with the computational platform.

5. The method of claim 3, wherein the computational topology is comprised of Storm Bolts, Spouts and Streams.

6. The method of claim 3, wherein a mediator facilitates communications between the topology design component and the computational platform.

7. The method of claim 3, wherein the one or more nodes associated with the topology design component consume the data streams from their respective computational platform nodes.

8. A computer program product for generating a computational topology for a computational platform, the computer program product comprising:
one or more computer readable storage media and program instructions stored on the one or more computer readable storage media, the program instructions comprising:
program instructions to, generate, by a topology design component, one or more nodes associated with a topology in a format associated with the topology design component;
program instructions to, generate, by the topology design component, logic associated with the one or more nodes, respectively;
program instructions to, communicatively connect, by the topology design component, the one or more nodes based on a desired data flow path;
program instructions to, transform, by the topology design component, the one or more nodes, the logic and the desired data flow path to a computational topology in a format associated with a computational platform; and
program instructions to, deploy, by the topology design component, the computational topology to the computational platform for execution.

9. The computer program product of claim 8, further comprising:
program instructions to, receive, by the topology design component, data streams associated with an operational status of the computational topology executing on the computational platform; and
program instructions to, debug, by the topology design component, the computational topology based on information associated with the data streams.

10. The computer program product of claim 9, wherein the topology design component is Node-RED by International Business Machines Corporation and the computational platform is Storm by Apache Software Foundation.

11. The computer program product of claim 8, wherein the logic is developed in JavaScript and executed by a JavaScript engine associated with the computational platform.

12. The computer program product of claim 10, wherein the computational topology is comprised of Storm Bolts, Spouts and Streams.

13. The computer program product of claim 10, wherein a mediator facilitates communications between the topology design component and the computational platform.

14. The computer program product of claim 10, wherein the one or more nodes associated with the topology design component consume the data streams from their respective computational platform nodes.

15. A computer system for generating a computational topology for a computational platform, the computer system comprising:
one or more computer processors;
one or more computer readable storage media;
program instructions stored on the one or more computer readable storage media for execution by at least one of the one or more computer processors, the program instructions comprising:
program instructions to, generate, by a topology design component, one or more nodes associated with a topology in a format associated with the topology design component;
program instructions to, generate, by the topology design component, logic associated with the one or more nodes, respectively;
program instructions to, communicatively connect, by the topology design component, the one or more nodes based on a desired data flow path;
program instructions to, transform, by the topology design component, the one or more nodes, the logic and the desired data flow path to a computational topology in a format associated with a computational platform; and
program instructions to, deploy, by the topology design component, the computational topology to the computational platform for execution.

16. The computer system of claim 15, further comprising:
program instructions to, receive, by the topology design component, data streams associated with an operational status of the computational topology executing on the computational platform; and
program instructions to, debug, by the topology design component, the computational topology based on information associated with the data streams.

17. The computer system of claim 16, wherein the topology design component is Node-RED by International Business Machines Corporation and the computational platform is Storm by Apache Software Foundation.

18. The computer system of claim 17, wherein the logic is developed in JavaScript and executed by a JavaScript engine associated with the computational platform.

19. The computer system of claim 17, wherein the computational topology is comprised of Storm Bolts, Spouts and Streams.

20. The computer system of claim 17, wherein a mediator facilitates communications between the topology design component and the computational platform.
